(19) United States
(12) Patent Application Publication
(10) Pub. No.: US 2010/0296428 A1
(43) Pub. Date: Nov. 25, 2010

(54) A ROBUST SYSTEM AND METHOD FOR WIRELESS DATA MULTICASTING USING SUPERPOSITION MODULATION

(76) Inventor: Pin-Han HO, Waterloo (CA)

Correspondence Address: MILLER THOMPSON, LLP, Scotia Plaza, 40 King Street West, Suite 5800, TORONTO, ON, M5H 3S1, CA

(21) Appl. No.: 12/679,915

(22) PCT Filed: Sep. 26, 2008
(86) PCT No.: PCT/CA08/01689

§ 371 Date: Mar. 25, 2010

Related U.S. Application Data
(60) Provisional application No. 60/976,007, filed on Sep. 28, 2007.

(51) Int. Cl. H04H 20/71

(52) U.S. Cl. 370/312

(57) ABSTRACT

A method for transmitting data over a wireless network to a plurality of receivers connected to the wireless network is provided consisting of applying a superposition coded multicast or broadcast so as to create a multi-resolution multicast or broadcast signal to transmit data to the plurality of receivers as a scalable multicast or broadcast. The method consists of separating the data into one or more quality layers; converting the data in each quality layer into individual protected layer data streams by applying a protection or robustness means; modulating each said protected layer data stream using a modulation means, the modulations means for each said protected layer data stream not necessarily being the same; superimposing the modulated data of all layers into a single broadcasting or multicasting transmission block; and transmitting the single broadcasting or multicasting transmission block to the plurality of receivers linked to the wireless network.

### PRIORITY CLAIM

This application claims priority from U.S. Provisional Patent Application No. 60/976,007 filed Sep. 28, 2007.

### FIELD OF THE INVENTION

The present invention relates generally to wireless communication, and more specifically to techniques for enabling wireless data multicasting.

### BACKGROUND OF THE INVENTION

Wireless communication systems are widely deployed to provide various communication services such as voice, data, video, their variation or combinations and so on. These systems may be capable of providing communication for multiple users (or receivers) simultaneously by sharing the available system resources, in which one or more information instances can be expected by these multiple receivers. Some examples of such systems include code division multiple access (CDMA) systems, time division multiple access (TDMA) systems, frequency division multiple access (FDMA) systems, orthogonal frequency-division multiple access (OFDMA) and time division-Synchronous code division multiple access (TD-SCDMA) systems.

Multicasting or sharing a transmitted signal with information among a group of receivers who are interested in the same content (e.g. data, video, audio, etc.) is generally an effective and scalable way to deliver bandwidth-intensive data in wireless or even wired infrastructure because duplicated deliveries of the same copy of data can be prevented. However, the multi-user fading diversity is an intrinsic nature in a wireless medium, in which receivers commonly have different channel conditions in relation to the base station (BS) (or the transmitter) at any time instant. Under such heterogeneous channel conditions among receivers, a single optimal transmission rate or strategy to send (multicast) common information to all receivers that utilizes the transmission medium efficiently is difficult. FIG. 2 illustrates the moment that a multicast signal representing data from a source is transmitted from the BS to all interested receivers—the subscriber stations (SSs)—in an IEEE 802.16 Point-to-Point network, in which the multicast signal is modulated with a scheme for the high transmission rate (e.g. 16 QAM). Due to the heterogeneous channel conditions among different SSs at that moment, multicast signals modulated in 16 QAM are not decodable by those SSs who have a lower signal-to-noise ratio (SNR) in their channels and only support BPSK (a modulation scheme requiring less SNR for decoding but also with a lower transmission rate). The channel condition of each receiver is time-varying, which means a receiver that can only support BPSK now may be able to support 16 QAM at the next moment, or vice versa. However, if the BS conservatively continues to use BPSK for multicasting data all the time, the channels are wastefully underutilized for those 16 QAM-supported SSs that have good channel conditions.

Superposition modulation can be adopted at the transmitter to embed multiple information instances directed to different receivers in a single wireless signal. Multi-resolution of demodulations in such a special signal can be used by a receiver to decode the signal partially, to obtain its own information when its channel is not good. Whereas, a good-channel receiver can completely decode the same signal and get its own interested information by first decoding the information it is not interested in and removing it from the whole signal. However, due to the instantaneous and fluctuating nature of a fading channel, certain amounts of data in the signal (especially the interested information about higher video quality) are lost forever or in error even for a receiver with a typically well-performing channel during those moments that the channel is bad. This creates a significant limit for many commercial applications where quality assurance is a requirement.

There are several types of prior art approaches for wireless multicasting.

### Type-1 Approach:

This type of approach proposes to adapt the channel conditions by adjusting the transmission rate, power allocation, error protection scheme, etc. or combination of these in a cross-layer design, in order to achieve the optimal utilization of throughput and achievable video quality of a receiver.

However, these adaptive approaches generally focus on one-to-one communications. Duplicated deliveries are generally required between each receiver and the BS for sending the same video data, which does not efficiently consume the bandwidth to scale the system capacity to large-scale video or data streaming for a large number of receivers.

### Type-2 Approach:

This type of approach adopts multicast for transmission at the BS. A single transmission rate or scheme is selected over the multicast signal for all receivers, so that all receivers are able to receive the video data simultaneously according to the selected scheme.

However, the selected transmission rate or scheme is not optimal for all receivers due to the multi-user channel diversity problem. The channel of some receivers will be underutilized, or some receivers can not decode the received signal since the SNR requirement of the transmission scheme is not fulfilled. Implementations under this approach generally do not consider the nature of scalable video coding and the use of superposition coding together to overcome the multi-user channel diversity over a multicast environment. The prior art approaches generally use superposition modulation for broadcasting different data inside a transmission block for different receivers. The prior art does not provide for superposition modulation for sending the same video to the same interested group under heterogeneous channel conditions.

### Type-3 Approach:

This type of approach adopts multicast for transmission at the base station with superposition modulation, so that some receivers can receive additional data occasionally during the opportunities that their channels are good enough for decoding the additional data modulated by a high order modulation scheme.

WO/2005/032035 by Qualcomm [1] presents the techniques for performing superposition modulation/demodulation for broadcasting in a multi-antenna communication system. The system may be a multiple-out single input (MISO) system with multiple antennas at a transmitter, a single-input multiple-output (SIMO) system with multiple antennas at a receiver, or a multiple-input multiple output (MIMO) system with multiple antennas at both the transmitter and receiver.

She et al. [3] introduces the use of superposition modulation incorporating layered video coding to multicast a video stream for IPTV services over WIMAX, which can overcome the intrinsic problem of multi-user channel diversity by creating multi-resolution modulations of multicast signals. With the same multicast signal, receivers with good channel conditions can demodulate the data from both the base and enhancement quality layers for full video quality, whereas receivers with bad channel conditions can still demodulate and obtain the data of base layer quality.

[1] and [3] do not discuss the possibility of strategically using protection codes in conjunction with superposition modulation in order to further improve the capacity and robustness of the video quality under wireless multicast transmission. There is no notion at all to recover the loss of higher quality video data in those instances that a receiver only obtained “base layer” data during a bad channel condition, and/or to make use of “enhancement layer” data obtained during a good channel condition. Chan et al. [2] investigates an embedded multicast/broadcast approach for transport of digital video over spread-spectrum code-division multiple access (CDMA) cellular networks. By taking into consideration both the interference-limited and bandwidth-limited characteristics of a CDMA system, the authors propose a cross-layer approach incorporating adaptive power allocation and channel coding strategies and effectively match a discrete cosine transform based scalable motion-compensated video encoder to an embedded multiresolution modulation scheme to simultaneously deliver a basic quality-of-service (QoS) to less capable receivers while maximizing both the QoS for more capable receivers and the system capacity. Using methods disclosed under this approach, certain amounts of data are never obtained, especially for higher quality video layers that are still lost or become erroneous during the timeslots that the associated channel conditions are poor or not-so-good. Depending on the involved video coding, incomplete sets of video data in the higher quality layers may not be useful at all to the receivers. Therefore, received data in these timeslots, where only partial data of higher quality layers is obtained, still constitutes a wasteful usage of superposition coded multicast.

### Type-4 Approach:

This type of approach applies a protection encoding on the video data, in order to enable more robust delivery. Lost data due to bad channel conditions can be recovered if the amount of received data meets the recovery requirement of the chosen protection encoding scheme.

Recovering the lost data by retransmitting the same data is common in many wired and wireless communications, but fails in scaling up support or efficiency when the frequency of errors and number of receivers are large, especially for bandwidth-demanding video streaming services. Mujumdar et al. [5] addresses the problem of real-time video streaming over wireless LANs for both unicast and multicast transmission. A novel hybrid Automatic Repeat reQuest (ARQ) algorithm that efficiently combines forward error control (FEC) coding with the ARQ protocol is proposed in this disclosure. For the multiple-user scenario, the problem of real-time video multicast is formulated as an optimization of a maximum regret cost function across the multicast user space. The data recovery of the proposed idea is to send a single parity packet to multiple receivers to replace their own missing data packet without individual retransmission of their lost packets. This approach is only efficient for small multicast local network as stated in the article. The channel diversity problem is not discussed at all here.

Chou et al. [4] explores layered multiple description codes, which generate a set of MDC packets to describe a set of video information, such as a group of video frames. (GoF). Each MDC packet contains data of multiple video quality layers. Low bandwidth clients can get the base layers of video quality by obtaining a smaller set of MDC packets to receive a base MDC layer, for example, while high-bandwidth clients can get the base and enhancement quality layers for higher video quality by obtaining the complete or larger set of MDC packets. However, the application of such protection codes in wireless multicast and a solution to the multi-user channel diversity problem are not discussed and illustrated at all. Most importantly, each MDC packet is assumed to be completely received for its expected purposes. However, partial reception of MDC packets occurs commonly in wireless communication, which is not assumed or discussed for any utilization at all in this work.

The prior art use of protection encoding, especially those with multiple descriptions, are designed to work in a wired infrastructure with multiple network paths between a transmitter to a receiver or a group of receivers, in which each packet contains protected data of all quality layers for a video bitstream. The connectivity/reliability and transmission capacity of such a wired medium connecting the transmitter and the receiver(s) is generally much more reliable than that of a wireless channel. Therefore, the loss of packets is mostly because of the buffer overflow in the intermediary devices due to traffic congestions, or transmission time-out due to long waiting time in the transmission buffer.

When transmitting a group of MDC packets to a receiver or a group of receivers, each packet would experience more or less the same probability of loss when a consistent transmission capacity is provided to each packet along the delivery path. It is important to ensure that a sufficient number of the lower quality layer packets are received. Otherwise, any higher quality layer packets received are of no use for improving video quality. This naturally creates a sense that the importance of the lower quality layer data is higher than that of the higher layer data. Therefore lower quality data needs a more robust protection to allow for a lower packet reception requirement (i.e. smaller number of MDC packets required). If it is using Reed-Solomon [RS (N, K)] code as the protection codes, that means a smaller number, K, of successfully received information blocks out of a constant N protected information blocks should be selected for an easier recovery of the lower quality layer data, especially where there is a constraint of bandwidth to transmit limited number of MDC packets. Therefore, the prior art generally concludes the use of an increasing order of K value from the lower layer to the higher one, in which the importance of data in the lower layer is higher.

Under such wired infrastructure, a packet containing bitstream data of multiple quality layers is either completely lost or received as a whole for contributing to the recovery effect. A partial reception of an MDC packet is not meaningful or being utilized at all by any previously proposed scheme.

On the contrary, the transmission capacity and connectivity of a wireless channel between a transmitter and a receiver are time-varying and unreliable due to the channel fading effect, which are characterized with a fluctuated transmission capacity and a higher rate of packet loss. This especially creates a huge challenge to multicast common information to multiple receivers at the same time under the heterogeneity of channel conditions among receivers with the transmitter. A multicast signal simply containing the data of all quality layers and transmitted using a single or mono-resolution modulation scheme at a BS will not be fully receivable by all receivers, since there are limited receiving rate and demodulation capability of those receivers with less-performing channel conditions. This poses a very unique problem to, for example, multicast scalable video bitstreams in wireless, which requires the support of multi-resolution modulation schemes within a single multicast transmission, while partial and full video quality can still be obtainable from the same multicast signal for receivers with less-performing and good channel conditions respectively.

There is a need for a system and method that enables multicasting that addresses the aforesaid disadvantages. In particular there is a need for a system and method for multicasting that addresses heterogeneous channel conditions efficiently and robust data recovery of diverse errors among receivers effectively. There is a need for a system and a method for multicasting that provides good data capacity utilization, particularly in the context of relatively large amounts of data (e.g. high quality video). There is a need for a system and method for wireless multicasting that provides these benefits in a manner that is suitable for a wide range of receivers, thereby enabling cost effective implementation using existing receivers or relatively low cost receivers. There is a need for a system and method to further improve the data capacity (e.g. improve video quality if video bitstreams are transmitted) for those receivers obtaining “base stream” data when their channels are bad and some “enhancement stream” data when their channels are good where superposition coding is used in conjunction with multicast or broadcast.

### SUMMARY OF THE INVENTION

In one aspect of the present invention, a method for transmitting data over a wireless network to a plurality of receivers connected to the wireless network is provided, the method characterised by: applying a superposition coded multicast or broadcast so as to create a multi-resolution multicast or broadcast signal to transmit data to the plurality of receivers as a scalable multicast

In another aspect of the present invention, a method for transmitting data via a wireless network to a plurality of receivers connected to the wireless network is provided, the method characterised by: (a) separating the data into one or more quality layers; (b) converting the data in each quality layer into individual protected layer data streams by applying a protection or robustness means; (c) modulating each said protected layer data stream using a modulation means, the modulations means for each said protected layer data stream not necessarily being the same; (d) superimposing the modulated data of all layers into a single broadcasting or multicasting transmission block; and (e) transmitting the single broadcasting or multicasting transmission block to the plurality of receivers linked to the wireless network.

In a particular aspect of the present invention, the modulation means is varied depending on the quality layer. A plurality of modulation means is provided, and each of the modulation means is selected for a quality layer to form the superimposed wireless signal. A modulation means associated with a relatively low SNR requirement is used for quality layers consisting of relatively low quality data, and a modulation means associated with a relatively high SNR requirement is used for quality layers consisting of relatively high quality data.

In a still other aspect of the present invention, a relatively robust protection encoding means is applied to quality layers consisting of relatively high quality data, and a less robust protection encoding means is applied to quality layers consisting of relatively low quality data.

In another aspect of the present invention, a system for transmitting data via a wireless network to a plurality of receivers is provided, the system characterised by: a multicast or broadcast computer linked to the wireless network, the multicast or broadcast computer being operable to (a) separate the data into one or more quality layers; (b) convert the data in each quality layer into individual protected layer data streams by applying a protection or robustness means; (c) modulate each said protected layer data stream using a modulation means, the modulations means for each said protected layer data stream not necessarily being the same; (d) superimpose the modulated data of all layers into a single broadcasting or multicasting transmission block; and (e) transmit the single broadcasting or multicasting transmission block to the plurality of receivers linked to the wireless network; characterised in that each of the plurality of receivers is thereafter operable to receive such modulated layers, and demodulate and decode such layers, and reconstruct said data from said layers.

In a yet further aspect of the present invention, a computer program product for transmitting data via a wireless network to a plurality of receivers is provided, the computer program product characterised by a multicast or broadcast computer linked to the wireless network, the multicast or broadcast computer being characterised by: (a) a computer readable medium including software instructions; and (b) the software instructions for enabling the computer to perform predetermined operations, the predetermined operations including the steps of: (i) separating the data into one or more quality layers; (ii) converting the data in each quality layer into individual protected layer data streams by applying a protection or robustness means; (iii) modulating each said protected layer data stream using a modulation means, the modulations means for each said protected layer data stream not necessarily being the same; (iv) superimposing the modulated data of all layers into a single broadcasting or multicasting transmission block; and (v) transmitting the single broadcasting or multicasting transmission block to the plurality of receivers linked to the wireless network; characterised in that each of the plurality of receivers is thereafter operable to receive such modulated layers, and demodulate and decode such layers, and reconstruct said data from said layers.

In a still further aspect of the present invention, a system for receiving data transmitted through a wireless network by one or more multicast or broadcast systems, said data being encoded, modulated, and superimposed prior to transmission, is provided, the system characterised by a receiving computer linked to one or more subscriber stations operable to: (a) receive a transmitted block of signals; (b) demodulate the said transmitted block of signals into a superimposed set of data; (c) separate the superimposed set of data into one or more encoded layers; (d) decode said one or more encoded layers into one or more quality layers; (e) recover the lost or corrupted data of one or more said quality layers; and (f) reconstruct said data from said one or more quality layers.

In yet another aspect of the present invention, a computer program product for receiving data transmitted through a wireless network by one or more multicast or broadcast systems, said data being encoded, modulated, and superimposed prior to transmission, is provided, the computer program product characterised by a multicast or broadcast computer linked to one or more subscriber stations, the multicast or broadcast computer being characterised by: (a) a computer readable medium including software instructions; and (b) the software instructions for enabling the computer to perform predetermined operations, the predetermined operations including the steps of: (i) receiving a transmitted block of signals; (ii) demodulating the said transmitted block of signals into a superimposed set of data; (iii) separating the superimposed set of data into one or more encoded layers; (iv) decoding said one or more encoded layers into one or more quality layers; (v) recovering the lost or corrupted data of one or more said quality layers; and (vi) reconstructing said data from said one or more quality layers.

### BRIEF DESCRIPTION OF THE DRAWINGS

FIG. 1 illustrates a compressed scalable bitstream with 2 quality layers.

FIG. 2 illustrates the moment that a multicast signal is transmitted from the BS to all interested receivers—the subscriber stations (SSs)—in an IEEE 802.16 Point-to-Point network.

FIG. 3 illustrates the process of adding robustness on each K, data block to form N protected units of layer i.

FIG. 4 illustrates protected units of layer i formed by a RS code (N, Kᵢ).

FIG. 5 illustrates the storage of PUs of layer 1 and layer 2 in L1 and L2 buffers awaiting formation of SPC multicast signals.

FIG. 6 illustrates a base station transmitting all PUs of all quality layers of a video bitstream with superposition coded multicast.

FIG. 7 illustrates multi-user diversity fading conditions, in an example embodiment where SS-1, SS-2 and SS-3 are receiving continuous SPC multicast signals from a BS at the same time.

FIG. 8 illustrates recovery of lost Pus, in accordance with the present invention in one aspect thereof.

FIG. 9 illustrates the process by which a complete set of video bitstream of a GoF can still be recovered even where no PUs are received in one of the timeslots.

FIG. 10 illustrates the operational orders of the elements of the present invention, in one aspect thereof.

FIG. 11 illustrates a representative example of the gain achieved by the present invention, in one aspect thereof.

FIG. 12 illustrates a representative example of the improvements achieved in one frame of video by the present invention, in one aspect thereof.

### DETAILED DESCRIPTION OF THE INVENTION

### Overview

The present invention is operable to increase the capacity and robustness of data multicasting in wireless communication solutions, such as wireless communication network using WIMAX, LTE, any similar or evolving wireless standard, by means of an advanced joint source and channel coding method and system as described below, and variations thereof. An example of application of the present invention is in connection with broadband multimedia services over WIMAX for a certain quality assurance such as IPTV or mobile TV services, Internet-based advertisements or any one-to-many video communications over wireless.

The present invention is described below by explaining four major aspects thereof. These are described individually with an example of scenario and suggested design parameters for illustration purposes. However, the present invention is not limited to the presented examples and associated parameters, which can be expanded, transformed or induced to be applicable other variations of applications. It also should be understood that the invention is not limited to a particular implementation of the present invention. Also, the disclosure of the invention should not be read as requiring a particular number or sequence. In fact, it may be obvious to a person skilled in the art to implement the invention such that one or more of the method steps described below are subsumed into one another, or expanded, so as to provide more or less steps than described, without departing from the present invention.

In one aspect of the present invention, a system and method for multicasting/broadcasting is provided, in which each of a plurality of receivers may receive data from a source (a single or collection of data file(s) or a live data generator also being referred to as a “source” in this disclosure, for convenience), or a part of the data file sufficient to provide substantial quality of use of the part of the source relative to the source in its entirety, including where channel conditions vary from receiver to receiver, by applying (i) protection coding at the source and (ii) superposition coding at the channel. Data from the source could be generated with multiple quality layers and/or protection could be applied on each layer.

In one aspect of the present invention, data of different quality layers may be modulated by different modulation schemes: (1) data of a relatively lower quality layer may be modulated using a scheme having a relatively lower SNR requirement, and (2) data from an enhancement or a relatively higher quality layer may be modulated using a scheme having a relatively higher SNR requirement. If a receiver with a good channel condition is able to demodulate the data from a modulation scheme with a relatively higher SNR requirement, then it may be able to demodulate the data from the modulation scheme with a relatively lower SNR requirement. Otherwise, the receiver may still be able to demodulate the data from the scheme with a relatively lower SNR requirement when the channel is not as good. Over a period of timeslots for transmission at BS with SCM, a receiver may experience good channel conditions for a portion of the timeslots, which results in a chance to demodulate and receive data from the base quality layer, and another chance to demodulate and receive data from the enhancement quality layer (assuming there are 2 only quality layers in the data stream). Whereas under another portion of the timeslots under worse channel conditions the receiver may still have a chance of demodulating and receiving data from the base quality layer. This finer granularity of partial data reception within a single transmission will not happen if it is multicasting in a wired infrastructure, where a multicast packet in each transmission will be either successfully received or not.

Selective modulation in accordance with the present invention occurs contrary to what was done in accordance with the prior art, and provides good results. The prior art assumed that the lower quality data was of higher importance. In effect, however, due to the channel fading effect resulting in time-varying transmission capacity and connectivity between a transmitter and receiver, in the context of wireless multicast, the present invention provides better results.

In another aspect of the present invention, a relatively robust protection encoding means may be applied to quality layers consisting of relatively high quality data, and a less robust protection encoding means may be applied to quality layers consisting of relatively low quality data. This is because in accordance with SCM, as used in the present invention, the chances (or timeslots) of receiving data of a relatively lower quality layer may generally be more and easier than those of receiving data of a relatively higher quality layer regardless of the total period of timeslots. Accordingly, in accordance with the present invention, data from the relatively higher quality layer with a relatively higher demodulation SNR requirement may be protected using a more robust protection code, such that the whole layer of information from the source can be recovered easier by using a smaller number of K, in the protection code on a higher quality layer.

Again, while the prior art refers to use of an increasing order of K values starting from the lower layer for decreasing effect of robustness/protection, the present invention, again counter-intuitively, provides for the opposite with improved results in the context of wireless multicast, given the parameters described herein.

The present invention takes the opposite approach to the prior art in ordering the K value (decreasing order) from the first layer to subsequent layers, which is also the reverse from prior art use of protection encoding. Data of the relatively higher layer will be more robustly protected, even though they are relatively less important than those from the lower layer.

The present invention is intended to increase the capacity and robustness of data multicasting in the wireless communication network, such as WIMAX, LTE, TD-SCDMA systems or any future wireless broadband systems by way of an advanced joint source and channel coding technique and its variations. This is particularly important to the modern broadband multimedia services over WIMAX for a certain quality assurance such as IPTV or mobileTV services, Internet-based advertisements or any one-to-many video communications over wireless.

One potential embodiment of the present invention transmits a video bitstream to multiple wireless receivers simultaneously. This potential embodiment will be used to illustrate the system and methods of the present invention, but as stated above, the present invention is not limited to this embodiment.

### I. Video Bitstreams by a Scalable Video Coding

Data representing a set of information, such as a group of video frames (GoF) may be encoded and compressed by an advanced coding scheme into scalable bitstreams with two or more conceptual quality layers (i.e. the successive information with layered structure, wherein the data of a higher layer will refine the lower layer to provide better overall information). A GoF may consist of any number of video frame(s) ranging from one to many. Certain parameters and coding methods may be described herein, but the present invention is not limited to a particular scalable video coding for such type of conceptual quality layers or quality segmentations, or to a total number of quality levels. Receivers with heterogeneous receiving performance may still be able to reconstruct a certain quality of the information depending on the number of layers of data received.

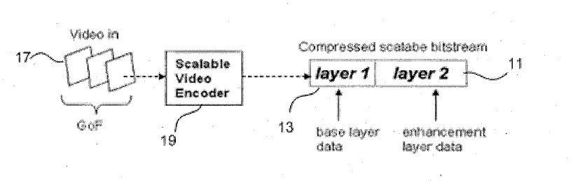

FIG. 1 illustrates a compressed scalable bitstream with two quality layers 11, 13 (the number of quality layers may be any number from one to many), each GoF 17 enabled by a scalable video coding 19. The most important information for minimal acceptable video quality or a subset of video data of this GoF 17 may generally be included in a base layer 13 (or layer 1) of the bitstream, while other information or a subset(s) of the same GoF 17 may generally be put into a second or subsequent layer 11 typically called an enhancement layer (or layer 2) of the bitstream. The quality of the video frames perceived by a decoder in a receiver device can be improved by a certain degree if the data in this enhancement layer 11 is obtained completely or even partially.

### II. Adding Robustness to Video Bitstreams by a Protection/Redundancy Coding

The data of a bitstream in a layer i may be divided into a number of data blocks with a size of Kᵢ bytes in each block with a unique property that K₁≧Kᵢ+1 among all layers, where a smaller value of i refers to a lower quality layer. Every Kᵢ bytes of data block will then have applied to it a protection coding to become a N byte long protected units (PUs) (or a N-byte long protected units of data if each packet is one-byte in size with a packet ID).

The present invention is not limited to a particular protection coding scheme to generate these N or extended number of packets, so long as the scheme can recover all N or extended number of packets of a layer i, even where some packets are lost and/or erroneous upon reception, when there are at least Kᵢ packets or even less successfully received. A non-exhaustive list of protection coding algorithms may consist of codings such as Reed-Solomon, Fountain, Tornado, etc., all of which are generally known by those skilled in the field.

For the protection codes based on Reed-Solomon (RS), a RS code can be described by two numbers N, K, where N is the length of the codeword and K is the number of data symbols in the codeword

Using Tornado code [6] [7], slightly more than K of the N protected units are needed to recover the original K information units. However it has faster and linear encoding and decoding times.

The choice of N and K is important since a purpose of the invention is to multicast video or successive information robustly with high quality to a plurality of receivers. One major parameter that affects the values of N and K is the worst channel condition of a receiver in the group.

Determination of final N and K of each quality layer may be made online (in real-time) adaptively according to the worst channel currently or in average among the receivers by implementing an adaptive algorithm, described below, with the feedback of all channel conditions of receivers and interacting with the protection coding program. The choices of the values should maintain or maximize the expected amount of data to be obtained by a receiver for the expected video quality (PSNR) or other necessary parameter. Ideally, the value of K/N (the redundancy overhead ratio) should be minimized.

Offline determination of N and K values can also be achieved by using statistical records of the channel conditions of all fixed receivers in a deployed multicasting site, since the channel variation of a fixed receiver has a long term averaged value. The selection of the values may be selected to cover the worst channel condition found in the all statistical records for the expected video quality (PSNR) or other necessary parameter while the value of K/N (the redundancy overhead ratio) is minimized.

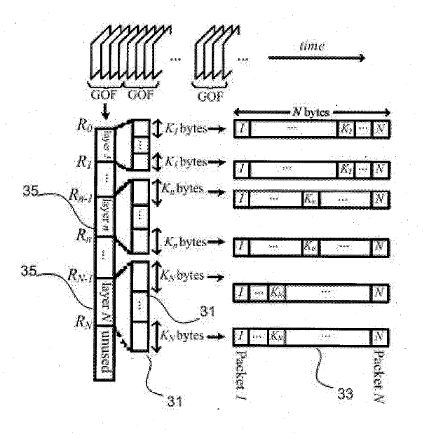

FIG. 3 illustrates the process of adding robustness on each Kᵢ data block 31 to form N protected units of layer i 35. For example, assume a GoF is encoded into a scalable bitstream with N conceptual quality layers 35. The video bitstream of layer i 35 may be segmented into a number of data blocks 31 with the size of Kᵢ bytes each. A Reed Solomon code, for example, with parameters N and Kᵢ (i.e. RS(N, Kᵢ)) can be applied on each Kᵢ data block to form N packets 33 (or PUs) of layer i 35.

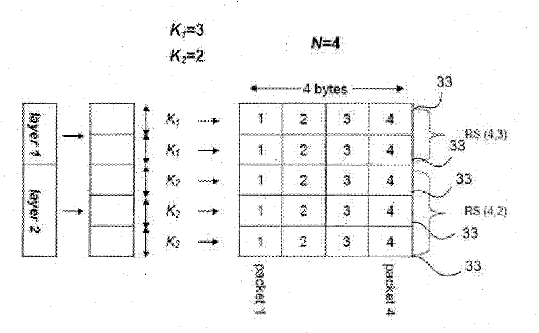

FIG. 4 illustrates PUs 33 of layer i formed by a RS code (N, Kᵢ). These PUs 33 of different quality layers of bitstream data may be (but need not be) stored in different buffers temporarily corresponding to their quality layers (or levels) after adding the robustness as shown in FIG. 3.

III. Modulation with Superposition Coded Multicasting

At this point, the PUs of bitstreams may be waiting in the buffers awaiting wireless transmission by a base station (BS) (or a transmitter) in a form of group signals, which can be receivable by a group of interested receivers simultaneously. This kind of one-to-many transmission is supported and also referred to as “multicasting” in many wireless technologies such as IEEE 802.16d/e (or WIMAX), IEEE 802.11 (or WiFi), HSDPA, CDMA, and other emerging wireless technologies.

Modulation enables conversion of digital information into a set of radio wave forms (or a modulated signal) for the wireless transmission. Advanced broadband wireless technologies like WIMAX support multiple modulation schemes to be switched in between adaptively according to the channel condition between the BS and a SS (or receiver).

Instead of using a single modulation scheme in a wireless multicast transmission at the BS, in one aspect of the present invention superposition modulation may be used, in which different modulation schemes may be employed concurrently to form modulated signals from different sets of data simultaneously. Multiple modulated signals may then be superimposed to form a single transmission block of a multicast signal. Depending on an application scenario, PUs of each buffer (corresponding to a quality layer) may be modulated by a specific modulation scheme with a certain transmission rate such that all PUs belonging to the same packet ID in different buffers may be modulated concurrently to form such superposition coded (SPC) multicast signal at one time.

### Transmission Rate for Sending Data of a Layer in Each Superposition Coded Transmission

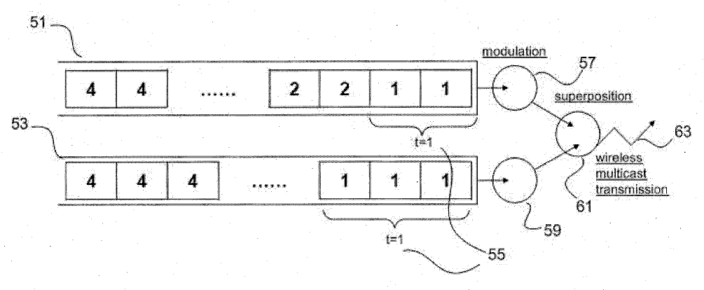

FIG. 5 illustrates the storage of PUs of layer 1 and layer 2 in L1 and L2 buffers 51, 53 awaiting formation of SPC multicast signals 63. Again assuming that there are only 2 quality layers in a video bitstream, the present invention may generate protected units for each layer using RS code with the parameters below as shown in FIG. 4. All PUs of layer 1 and layer 2 may be stored in L1 and L2 buffers 51, 53 respectively. For a given timeslot (e.g. at time t=1) of a wireless transmission, PUs with the packet ID=1 in L1 buffer 51 may be modulated with BPSK (level-1 data) 57, which requires a lower signal-to-noise ratio (SNR) of a channel for demodulation with a particular bit error rate (BER). For the same timeslot of wireless transmission, on the other side, PUs in L2 buffer 53 with the packet ID=1 may be concurrently modulated with QPSK 59, which requires a higher

SNR for demodulation for the same BER. Both modulated signals from L1 and L2 buffers 51, 53 may be superimposed 61 to form a combined modulated signal 63 for multicast transmission at the same time.

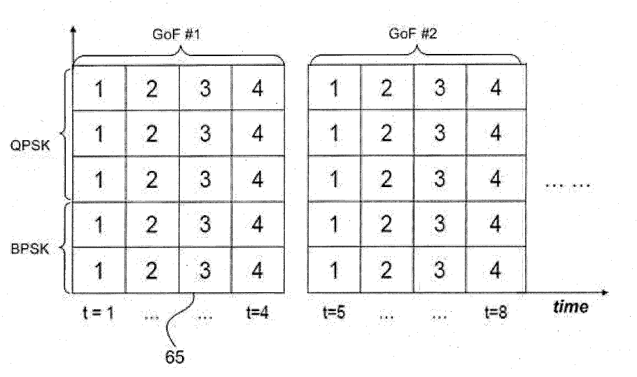

FIG. 6 illustrates a base station transmitting all PUs of all quality layers of a video bitstream with superposition coded multicast. The BS may repeat the same processes outlined above for a next set of PUs with the packet ID=2 65 in all buffers for the next available timeslot (e.g. at time t=2) and so forth. Once all PUs in the same GoF are modulated and multicasted, the same process may then be repeated for the next GoF and so on until the end of the video bitstream. By operation of the present invention, the BS may transmit video bitstreams (for example) in accordance with an optimal scheduling policy, and more importantly with minimal required transmission resources.

Within each timeslot t, the transmission rate of a modulation scheme R_{M,l} applied on the buffer for layer l must be fast enough to multicast all the PUs belonging to that layer of the MDC packet. Otherwise, the number of PU, the size of a PU and the duration of a timeslot should be adjusted. This may be a necessary condition for the BS to achieve long-term stability, and may thus be formulated into the following constraint for selecting a modulation scheme in each transmission:

$${R}_{M , l} \geq \frac{( {b}_{l} - {b}_{l - 1} )}{{K}_{l}} \times \frac{1}{t}$$

where R_{M,l} is the transmission rate (bits/second) of a modulation scheme within the set {BPSK, QPSK, 16 QAM, 64 QAM}; bₗ is the bit position of the video bitstreams up to quality layer l; Kₗ is the value for the RS code on layer l; and t is the duration of one timeslot assigned to a multicast transmission by a scheduling policy. The BS may repeat the same superposition process for the next set of PUs belonging to the 2^{nd} description in all buffers for the next available transmission timeslot (e.g. at time t=2) and so forth.

### IV. Demodulation in Each Individual Receivers (or Subscriber Station/SS)

Demodulation is the opposite procedure of modulation to turn a set of radio waves into digital information. All SSs (or receivers), in accordance with the present invention, may be operable to receive the same superposition coded multicast signal at the same timeslot within the range of a BS. However, not all of them may be able to demodulate and receive all the data that they are supposed to obtain originally from the same multicast signal due to the heterogeneity of their time-varying channel conditions (or the multi-user diversity of fading channel). The strength of a channel condition between a SS and the BS can be measured by a quantifiable value of signal-to-noise ratio (SNR). When a SNR value of a channel can meet the SNR requirement of a modulation scheme adopted in the buffer for a higher quality layer data (e.g. L2 buffer), the SS may be operable to demodulate and receive all the PUs of both the base and enhanced layers inside the received multicast signal of that timeslot. Otherwise, the SS may only be able to demodulate and receive the PUs belonging to the lower quality layer(s) (e.g. those from L1 buffer) from the same multicast signal or no PUs if the channel condition is very poor. Any demodulated data of layers 1 and 2 from the received superposition coded multicast signal may (but not necessarily) be stored temporarily in the corresponding buffers at the receivers before passing to the protection decoder and the video decoder for video playback in the receiver device.

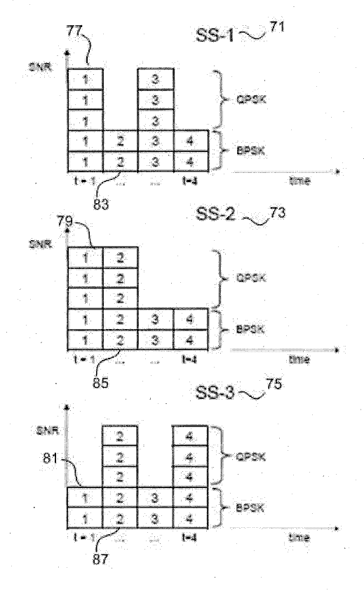

FIG. 7 illustrates multi-user diversity fading conditions, in an example embodiment where SS-1 71, SS-2 73 and SS-3 75 are receiving continuous SPC multicast signals from a BS at the same time. Due to the multi-user diversity of fading channel conditions, both SS-1 71 and SS-2 73 at the time t=1 can demodulate and receive all PUs 77, 79 of all video quality layers within the same multicast signal since both their channel conditions are good with a SNR supporting both QPSK and BPSK. However, SS-3 75 can only demodulate and receive PUs 81 belonging to layer 1 due to a lower SNR value of a less-performing channel between SS-3 75 and the BS. At the time t=2, the channel of SS-1 71 becomes bad with a lower SNR value sufficient to demodulate and receive PUs 83 of layer 1 only, whereas both SS-2 73 and SS-3 75 have a channel condition with a SNR sufficient to support QPSK and BPSK such that PUs 85, 87 of layer 1 and layer 2 in the multicast signal can be demodulated and completely received.

V. Recovery of Lost and/or Erroneous Protection Units

The use of superposition coded modulation/demodulation for multicast transmission allows those SSs (or receivers) to have opportunities to obtain more information for a higher video quality from the same signal of a wireless multicast addressed packet, whereas other SSs with a worse channel quality may still receive a basic video quality by only demodulating the lower layer data from the same multicast signal. Therefore, some PUs of the higher quality layers may still be lost or become erroneous under the timeslots where associated channel conditions are poorer. Another novel aspect of the present invention allows recovery of lost and/or erroneous PUs of different quality layers when a SS can successfully demodulate and receive Kᵢ PUs of a layer i, even when a multi-resolution modulation is employed alone.

Recovery of lost and/or erroneous protection units may be accomplished using the protection encoding described above under “Adding robustness to video bitstream by a protection/redundancy coding.”

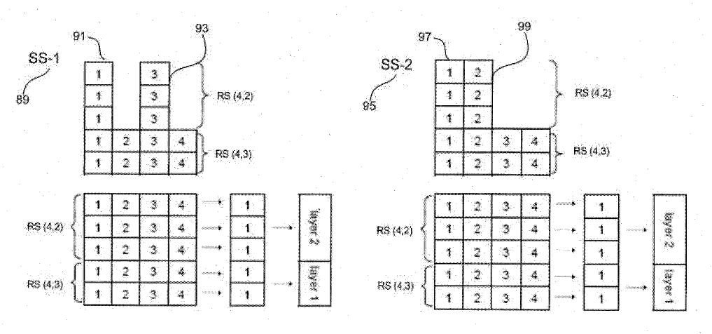

FIG. 8 illustrates recovery of lost PUs, in accordance with the present invention in one aspect thereof. SS-1 89 received PUs 91, 93 of layer 2 at timeslots, t=1 and t=3, and SS-2 95 received PUs 97, 99 of layer 2 from the first two timeslots. At the end, both SS-1 89 and SS-2 95 are able to recover their own lost PUs individually to deliver a complete set of video bitstream data of two quality layers for the highest quality of video playback. Recovery can be successfully achieved when K₂ PUs (where K₂=2) of layer 2 can be demodulated and received from any two different timeslots, since a Reed-Solomon code RS(4,2) is employed to form the PUs of layer 2 during the process of adding robustness.

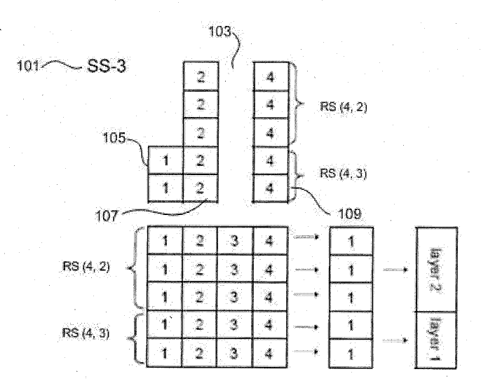

FIG. 9 illustrates the process by which a complete set of video bitstream of a GoF can still be recovered even where no PUs are received in one of the timeslots. Even with poor channel scenario where, for example, SS-3 101 did not receive any signal at all 103 due to negative network effects at timeslot t=3, a complete set of video bitstreams of 2 quality layers can still be recovered since there are still three timeslots 105, 107, 109 for receiving the PUs of layer 1.

### Implementation

One embodiment of the present invention in a wireless network may include a plurality of subscriber stations (receivers) and a base station (BS or transmitter) which connects to a video source of an IPTV service provider through a high speed backbone network (e.g. Gigabit Ethernet Networks or IP over Ethernet Passive Optical Network). These machines may form a last mile wireless broadband access (WBA) network and may be deployed in a town with different neighbourhoods, in which video streams can be multicasted wirelessly to each neighbourhood/community equipped with a subscriber station.

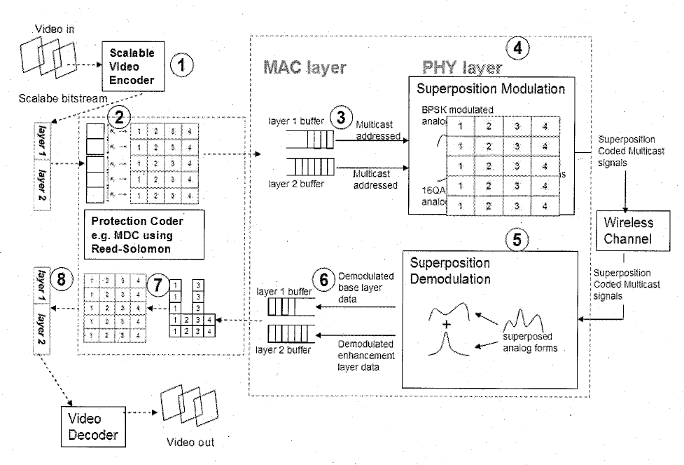

FIG. 10 illustrates the operational orders of the elements of the present invention, in one aspect thereof. The various aspects of FIG. 10 are more fully described below.

### Video Encoding and Decoding

The present invention is not limited to transmission of video bitstreams. For example, the video coding may work with any scalable video coding method that can generate encoded bitstreams with one or more conceptual quality layers (or levels) of video quality from an analog or digital video signal. This kind of video encoder can be implemented in the form of a hardware chipset, software, software running in a machine, or any similar form, which can be integrated within or interface with another system (software or hardware) for adding protection codes. For example, a software encoder using H.264/AVC-part 10 standards may be used to generate scalable bitstreams with multiple quality layers.

The video encoder may be located in proximity to the base station, or remotely installed at a distant location connected through the high speed network for transferring the video bitstream for wireless transmission. The video decoder may decode the received bitstream data and display the video immediately at the receiver device (e.g. mobile phone or portable media player). Sometimes, the video decoder may be installed in a set-top box device at the receiver location, which interfaces with a display unit such as TV, flat panel monitor, or any other video display device.

### Adding Protection Codes

Protection coding of the video bitstreams may be implemented by a software program or hardware chipset on a system with a protection algorithm (e.g. Reed-Solomon, Turbo product codes) to process and encode incoming data of video bitstreams from a video encoder. The bitstreams are passed to such software or system remotely for protection coding. In some cases, the video encoder may be built within the same system as another part of the software for such protection processing, in which the bitstreams are passed around within the same software or system. The protected bitstreams may be classified into different forms of classes and/or groups and then passed to the corresponding data buffers in the BS awaiting for modulation.

### Superposition Coded Multicast

As an example of implementation, superposition modulation may be implemented, for example, by means of hardware chipsets or programmable hardware chipsets within a BS to intake protected video bitstreams data from buffer(s) for modulation and superimpose the modulated signals together into a signal multicast transmission block according to power and transmission time allocation policy configured in the program inside the hardware chipset or the programmable hardware chipsets. These chipsets may then be interfaced with the components described above for preprocessing of the data.

This pre-processing of the data may be implemented in software or codes in hardware for the MAC layer of a transmission system, which may interface with the application or network layer to get the protected (or non-protected) bitstreams of each layer into the corresponding buffer awaiting modulation and wireless transmission. Multiple buffers, their data synchronization, persistence and other required processing for data integrity, as well as transmission, may also be implemented into this component.

### Demodulation of Superposition Coded Multicast

Demodulation of superposition coded multicast signal may also be implemented by means of hardware chipsets or the programmable hardware chipset in a fixed or portable/mobile subscriber station (receiver) to execute the demodulation of the received signal and pass the demodulated data into the corresponding buffers in the receiver device.

### Recovery of Data Lost or in Error

A software program or hardware chipset on a system may be implemented within a receiver device, or linked to a receiver device, to support the same protection algorithm used on the video source or transmitter system for decoding the protected units of video bitstream, which are successfully demodulated and stored in a memory means linked to the receiver, such as a buffer. The recovered bitstream data may be passed to the video decoder for further video decoding. This software may be integrated with other software resident on or linked to the receiver, or the hardware chipset functions may be integrated with existing hardware associated with the receiver.

Processing of demodulated data may be implemented in a software program or codes in hardware at the MAC layer of a receiver system, which may interface between the demodulation unit(s) in the PHY layer and the protection decoder in the receiver system. The protection decoder may be implemented using a software or hardware decoder at the receiver system. Finally, the video decoder may be implemented in software or hardware built into the receiver system, as long as the decoder can support the same scalable video coding standard used at the video encoder.

### Variations of Implementation

The systems of the present invention, in one aspect thereof, may be provided in an integrated form. For example, video encoding, protection coding, pre-processing, and superposition modulation may be integrated into the same transmitter system, or video encoding and protection coding may be integrated into the system sending the video source while pre-processing and superposition modulation may be integrated into the transmitter system.

Similarly, superposition demodulation, processing of demodulated data, protection decoding, and video decoding may be integrated into the same receiver system, or superposition demodulation and processing of demodulated data may be integrated at the wireless receiving system while protection decoding and video decoding may be integrated in the video display system.

However, the present invention is not limited to these implementations as long as the operational orders of the components, as previously illustrated in FIG. 10, are maintained.

The following is a simulation illustrating the advantages of the present invention, wherein it may provide better video quality. It should be noted that these parameters are for illustration of the advantages of the present invention only and are not meant to narrow the scope of the present invention or the parameters with which the present invention may be operable.

A simulation may include a video source with a constant frame rate of 30 frames per second, 2 quality layers being a base quality layer and enhancement layer, a fixed percentage of video data comprising the base quality layer, and superposition modulation conducted using BPSK for the base quality layer and 16 QAM for the enhancement layer. The simulation may also comprise two SSs, one with a high average channel SNR and one with a low average channel SNR. Rayleigh fading may be simulated such that in-channel fluctuations may occur from one transmission frame to the next. In a first simulation, the base layer may contain 40% of the video data for each frame. In a second simulation, the base layer may contain 80% of the video data for each frame. Assuming a varying Rayleigh fading channel, as described above, and constant channel conditions for simplicity, the simulation may indicate an increase in received video quality.

Comparing the frame-by-frame video quality according to the PSNR perceived by the SSs, it may be observed that both SSs receive better quality data than the legacy scheme. It may further be observed that the degree of gain achievable in terms of PSNR increases as the percentage of video data included in the base layer is reduced.

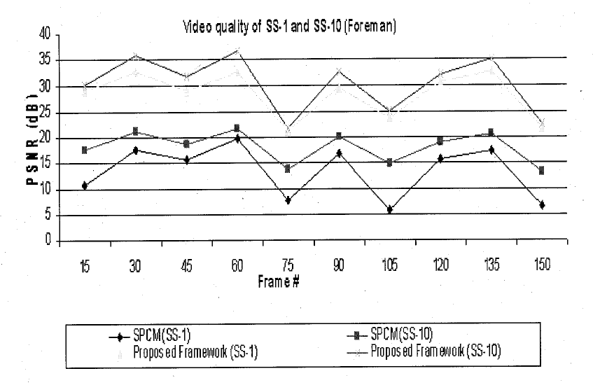

FIG. 11 illustrates a representative example of the gain achieved by the present invention, in one aspect thereof. It can be seen that PSNR using the methods of the present invention is higher than that of SPCM in the prior art.

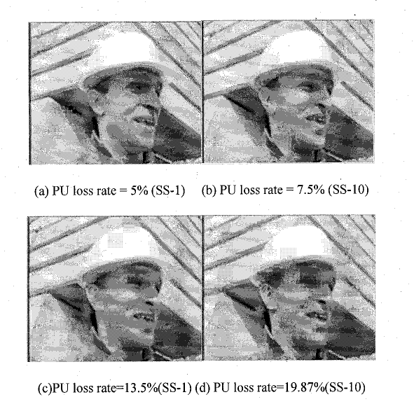

FIG. 12 illustrates a representative example of the improvements achieved in one frame of video by the present invention, in one aspect thereof It can be seen that the loss rate experienced, and the visual quality of the video frame, are improved in the present invention (FIGS. 12(a) and 12(b)) relative to that of the prior art (FIGS. 12(c) and 12(d)).

### Adaptive Parameter Selection for Perceived Video Quality Assurance

Using the method for optimal encoding and transmission parameters as described above, optimal performance may be achieved. However, a fast heuristic may alternatively be developed to initiate a compromise between performance optimization and computation speed. The impact on the quality of video multicast due to multi-user channel diversity and short-term channel fluctuation may be well mitigated.

### Determining Optimal Encoding and Transmission Parameters

According to the general rate-distortion theory of a video or information source, the distortion D(R) (i.e. a measurement of a video quality, wherein smaller distortion results in a better perceivable quality) may be monotonically decreasing as the number of bits used to represent an information. This in turn justifies that the distortion of a group of encoded video frames (or a set of information) perceived by a receiver may decrease if the total amount of obtained/recovered bitstreams at the receiver increases.

A model of describing the total amount of receivable/recoverable bitstreams of a video GoF or a set of information for the invented technology may be developed with the invention, which may facilitate an optimization for determining the optimal encoding parameters, transmission rate, and/or power allocations required to implement and/or deploy the invention under a practical environment.

As described above, the various factors affecting the optimal selection of the protection encoding parameters may include the modulation rate R_{M,i} selected for sending the data of each conceptual quality layer and the power allocation in each modulation for the data of quality layer i. For the long term stability, the modulation rate R_{M,i} applied on the buffer for layer i must be fast enough to multicast out all the PUs of a description of that layer within a timeslot t, which is affected by the amount of bitstreams and the protection parameners such as K and N of that layer if the reed-solomon code is employed.

Once the BS has selected the modulation scheme, R_{M,l}, for layer l, a successful demodulation of layer l by SS-m at the specific transmission rate, R_{M,l,m}(γ_{l,m}), can only happen if the associated SNR, γ_{l,m}, fulfills the required SNR lower bounds summarized as:

$${R}_{M , l , m} ( {γ}_{l , m} ) = \{ \begin{matrix}64 QAM , & if 18.5 dB \leq {γ}_{l , m} & and {R}_{M , l} = 64 QAM \\ 16 QAM , & if 11.5 dB \leq {γ}_{l , m} & and {R}_{M , l} = 16 QAM \\ QPSK , & if 6 dB \leq {γ}_{l , m} & and {R}_{M , l} = QPSK \\ BPSK , & if 3 dB \leq {γ}_{l , m} & and {R}_{M , l} = BPSK \\ fail , & otherwise & \end{matrix} \}$$

These lower bounds may be derived based on the WiMAX standard, but they may also be extended for any other existing or new modulation scheme by including the corresponding SNR lower bound. It may be critical to fulfill the required SNR lower bound for a successful demodulation of layer l. Otherwise, the SPCM signal may partially or completely fail to be decodable.

The expected bit error rate (BER), denoted as e_{l,m}, for receiving layer l bitstreams at SS-m may also be affected by its SNR, γ_{l,m}, of the associated channel with the approximated relations shown below. These approximations are commonly assumed for the indicated modulation schemes, as provided in the prior art. They may be used here to derive the following formulations. However, the following formulations and the framework provided by the present invention are still applicable when any of these BER approximations are modified for any new or existing modulation scheme.

$${e}_{l , m} ( {R}_{M , l , m} , {γ}_{l , m} ) = \{ \begin{matrix}Q ( \sqrt{{2}_{{γ}_{l , m}}} ) , & if {R}_{M , l , m} = BPSK \\ Q ( \sqrt{{γ}_{l , m}} ) , & if {R}_{M , l , m} = QPSK \\ \frac{1}{4} [ \begin{matrix}Q ( \sqrt{\frac{{γ}_{l , m}}{5}} ) + \\ 3 Q ( \sqrt{\frac{{γ}_{l , m}}{5}} )\end{matrix} ] + \frac{1}{2} Q ( \sqrt{\frac{{γ}_{l , m}}{5}} ) , & if {R}_{M , l , m} = 16 QAM \\ \begin{matrix}\frac{1}{12} [ \begin{matrix}Q ( \sqrt{\frac{{γ}_{l , m}}{21}} ) + Q ( 3 \sqrt{\frac{{γ}_{l , m}}{21}} ) + \\ Q ( 5 \sqrt{\frac{{γ}_{l , m}}{21}} ) + Q ( 7 \sqrt{\frac{{γ}_{l . m}}{21}} )\end{matrix} ] + \\ \frac{1}{6} Q ( \sqrt{\frac{{γ}_{l , m}}{21}} ) + \frac{1}{6} Q ( 3 \sqrt{\frac{{γ}_{l , m}}{21}} ) + \\ \frac{1}{12} Q ( 5 \sqrt{\frac{{γ}_{l , m}}{21}} ) + \frac{1}{12} Q ( 7 \sqrt{\frac{{γ}_{l , m}}{21}} ) + \\ \frac{1}{3} Q ( \sqrt{\frac{{γ}_{l , m}}{21}} ) + \frac{1}{4} Q ( 3 \sqrt{\frac{{γ}_{l , m}}{21}} ) - \\ \frac{1}{4} Q ( 5 \sqrt{\frac{{γ}_{l , m}}{21}} ) - \frac{1}{6} Q ( 7 \sqrt{\frac{{γ}_{l , m}}{21}} ) + \\ \frac{1}{6} Q ( 9 \sqrt{\frac{{γ}_{l , m}}{21}} ) + \frac{1}{12} Q ( 11 \sqrt{\frac{{γ}_{l , m}}{21}} ) - \\ \frac{1}{12} Q ( 13 \sqrt{\frac{{γ}_{l , m}}{21}} ) ,\end{matrix} & \begin{matrix} \\ \\ \\ \\ \\ \\ \\ \\ \\ \\ \\ \\ \\ \\ \\ \\ \\ \\ if {R}_{M , l , m} = 64 QAM\end{matrix} \begin{matrix} \\ \end{matrix}\end{matrix}$$

where Q(.) is a Q function.

Given e_{l,m} and (bₗ−bₗ₋₁), an average loss probability, ε_{l,m}, that the whole column of PUs of layer l in a partial MDC packet getting lost or erroneous at SS-m, may be derived as:

ε_{l,m}=1−(1−e_{l,m})^{b}^{ₗ}^{-b}^{_{l−1}}^{/K}^{ₗ}

Note that (bₗ−bₗ₋₁)/Kₗ may give the number of rows of the PUs in layer l of in a partial MDC packet.

In the present invention, in one aspect thereof, the erasure recovery of a quality layer at a receiver may strictly be a function of the number of partial MDC packets (i.e., the number of columns of PUs) that are received for that layer in a GoF rather than which of those packets (or PUs) are received. Therefore, the whole row of N PUs long of layer l at SS-m may be recoverable only if at least Kₗ PUs are successfully received in that row of layer l. Let Fₗ denote a random variable that represents the number of packet erasures in a group of N partial MDC packets of layer l. Then, the probability of getting N−Kₗ or fewer erasures in N partial MDC packets of layer l at SS m for a GoF may be approximated as:

$${P}_{l , m} = Pr \{ {F}_{l} \leq N - {K}_{l} \} = {\sum }_{j}^{N - {K}_{l}} ( \begin{matrix}N \\ j\end{matrix} ) {( {ɛ}_{l , m} )}^{j} {( 1 - {ɛ}_{l , m} )}^{N - j}$$

By considering that the bitstreams of layer l are only useful if layer l−1 is completely recoverable or received, the average number of receivable/recoverable bitstreams of layer l in a GoF obtained by SS-m, denoted as T_{l,m}, may be calculated as the following:

T_{l,m}=(bₗ−bₗ₋₁)Πᵢ₌₁^{l}P_{i,m}

Note that all involved loss events may be assumed to be independent based on the fact that the bit errors distributed independently due to the interleaving of data transmissions between multiple services stream at the BS across continuous timeslots. Therefore, the total average number of receivable/recoverable video bitstreams Tₘ (in bits) of a GoF with L layers by SS-m , may be expressed as:

Tₘ=Σₗ₌₁^{L}T_{l,m}

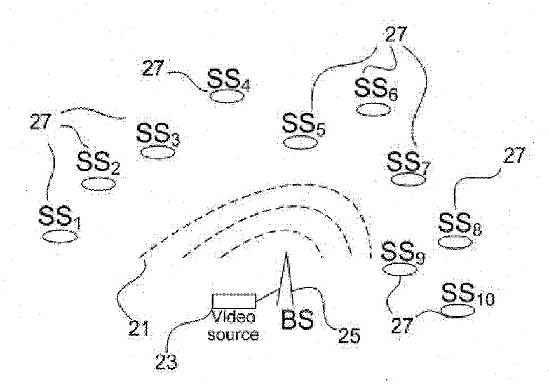

Since there may be a direct relationship between the distortion and bitstream boundaries in a GoF as illustrated in FIG. 2, the value of Tₘ may be regarded as a video quality measurement of a GoF for SS-m for the purpose of analysis. According to different application scenarios, a particular policy may be created to optimize Tₘ by selecting a proper power allocation, modulation schemes or even the values of N and K in the RS codes for different layers, under certain operational requirements including other QoS requirements and system constraints in the IPTV services.

### An Example for Optimization

It should be noted that the model provided by the present invention may be used to optimize any of the parameters described above. The following discussion is just one illustrative example and is not meant to narrow the scope of the preceding discussion. The formulations provided below are illustrative of this example only are also not meant to be applicable to all variations of the present invention as provided above.

The objective may be to minimize distortion by selecting the proper sets of power allocation p: {p₁, . . . , pₙ} and source data allocation K: {K₁, . . . , Kₙ} in each GoF given the protection overhead limit of value N and against other constraints, such as total power budget in each transmission as described.

Assume that the video bitstream with two quality layers is multicast through a WiMAX BS to a set of SSs with varying average SNRs, wherein the channel condition of each SS is subject to Rayleigh fading with a short-term channel fluctuation, and is evaluated according to the individual channel side-information feedback over a time window denoted as ω. Given the value N, the value of e_{l,m} may be determined by a set of operating points, including the value of Kₗ, power and modulation scheme assigned to a quality layer l, which in turn reflects the resultant video quality experienced at SS-m based on its total amount of receivable/recovable bitstreams of GoF. Let SS-j* be subject to the receiver with the worst channel condition during the time window ω in average. Since the SPCM signal is shared and receivable by all SSs, an optimal set of power pₗ and modulation rate R_{m,l} may be selected to improve the video quality of a GoF at SS j*. Thus, the objective may be to maximize the number of total received video bitstreams T_{j*} of a GoF, i.e., max T_{j*}=Σₗ₌₁^{L}T_{l,j*}.

Adopting such an optimization objective is based on the assumption that any SS j where j≠j*, will receive more video bitstreams than that by SSError! Objects cannot be created from editing field codes. under a diverse and fading channel during the time window, thereby leading to a better video quality. The optimization over all possible values of Kₗ, pₗ and R_{M,l} for both quality layers may be subject to the following constraint:

Error! Objects cannot be created from editing field codes.

In this example, L=2 since there are only two quality layers of video data in our present sample. Based on the analytical formulations above, the optimal operating point (Kₗ, pₗ, R_{M,l}) for each superposition coded multicast transmission for a GoF may be non-linear and discrete, and therefore cannot be solved by any commercially available integer program solver. Since the possible space of the total operating points of the proposed framework may be a limited and small number of combinations in a typical deployment, the optimization problem may be efficiently handled by using a less complicated but practical algorithm, such as an iterative search approach, in which a discrete ratio of each evaluating power allocation pairs may be set within the total power constraint under the limited possible set of modulation schemes with a limited set of practical K values related to N. The associated SNRs, supportable modulation and the resultant error rate of each quality layer (i.e. the probability that a quality layer is unrecoverable), respectively, as well as the final total receivable bitstreams T_{j*} of an optimized multicast transmission using the invention may be evaluated with all possible operating combinations. Optimal encoding and transmission rate may therefore be determined for generating the superposition coded multicast signal.

### Power Allocation in Each Modulation for the Data of Quality Layer i

For a given distance, the bit error rate (BER) of a received data of quality layer i may be affected by the power allocated to the modulation applied on the data of quality layer i during the transmission at the base station. Online and offline determination of N and K for each quality layer i may be designed according to the feedback of the current (for the real-time computation) or the worst (for the offline computation) BER of quality layer i to achieve an expected video quality (PSNR) of the video bitstream. Or, in other words, given all possible transmission rates, R_{M,l}, supported by a base station and a value of N as well as a set of K={K₁, K₂, . . . Kᵢ}, an optimization may be achieved to allocate appropriate powers P={P₁, P₂, . . . Pᵢ} to modulation schemes used in each transmitted signal or over a set of transmitted signals such that the best possible overall video quality for receivers can be offered.

### CITATIONS

[1] WO/2005/032035, “Hierarchical Coding with Multiple Antennas In A Wireless Communication System”, Qualcomm

[2] Y. S. Chan et al, “An End-to-End Embedded Approach for Multicast/Broadcast of Scalable Video over Multiuser CDMA Wireless Networks”, IEEE Trans. on Multimedia, Vol. 9, No. 3, April 2007

[3] J. She et al, “IPTV over WIMAX”, IEEE Communications Magazine, Vol. 45, No 8, August 2007

[4] P. A. Chou et al, “Layered Multiple Description Coding”, IEEE Packet Video Workshop, Nantes, France, April 2003

[5] Mujumdar et al, “Multicast and Unicast Real-Time Video Streaming Over Wireless LANs”, IEEE Tran. Circuit & Systems For Video Technology, Vol. 12, No. 6, June 2002

[6] M. Luby, M. Mitzenmacher, A. Shokrollahi, D. Spielman, V. Stemann, “Practical Loss-Resilient Codes”, Proceedings of 9th Annual ACM Symposium on Theory of Computing, 1997.

[7] M. Luby, M. Mitzenmacher, A. Shokrollahi, D. Spielman, “Efficient Erasure Correction Codes”, IEEE Trans. on Information Theory, Special Issue on Codes and Graphs and Iterative Algorithms, Vol. 47, No. 2, February 2001

[8] W. Ge, J. Zhang and S. Shen, “A Cross-Layer Design Approach to Multicast in Wireless Networks”, IEEE Trans. on Wireless Communications, vol. 6, no. 3, pp. 1063-1071, 2007

What is claimed is:

1. A method for transmitting data over a wireless network to a plurality of receivers connected to the wireless network characterised by: applying a superposition coded multicast or broadcast so as to create a multi-resolution multicast or broadcast signal to transmit data to the plurality of receivers as a scalable multicast.

2. A method for transmitting data via a wireless network to a plurality of receivers connected to the wireless network, the method characterised by:
(a) separating the data into one or more quality layers;
(b) converting the data in each quality layer into individual protected layer data streams by applying a protection or robustness means;
(c) modulating each said protected layer data stream using a modulation means, the modulations means for each said protected layer data stream not necessarily being the same;
(d) superimposing the modulated data of all layers into a single broadcasting or multicasting transmission block; and
(e) transmitting the single broadcasting or multicasting transmission block to the plurality of receivers linked to the wireless network.

3. The method of claim 2 characterised by providing the base information in the lowest layer and successively enriched or refined information in successively higher layers.

4. The method of claim 2 characterised by providing or obtaining a plurality of modulation means, and in order to reduce data loss a particular modulation means is selected based on differences in wireless network conditions at different receivers.

5. The method of claim 2 characterised by using a modulation means associated with a relatively low SNR requirement for quality layers consisting of relatively low quality data, and using a modulation means associated with a relatively high SNR requirement for quality layers consisting of relatively high quality data.

6. The method of claim 2 characterised by using a modulation means associated with a relatively low transmission rate for quality layers consisting of relatively low quality data, and using a modulation means associated with a relatively high transmission rate for quality layers consisting of relatively high quality data.

7. The method of claim 2 characterised by applying a relatively more robust protection encoding means to quality layers consisting of relatively high quality data such that the recovery of these layers can be achieved by smaller amount of data successfully received in these layers, and applying a relatively less robust protection encoding means to quality layers consisting of relatively low quality data such that the recovery of these layers can be achieved by relatively more amount of data successfully received in these layers.

8. A system for transmitting data via a wireless network to a plurality of receivers characterised by: a multicast or broadcast computer linked to the wireless network, the multicast or broadcast computer being operable to
(a) separate the data into one or more quality layers;
(b) convert the data in each quality layer into individual protected layer data streams by applying a protection or robustness means;
(c) modulate each said protected layer data stream using a modulation means, the modulations means for each said protected layer data stream not necessarily being the same;
(d) superimpose the modulated data of all layers into a single broadcasting or multicasting transmission block; and
(e) transmit the single broadcasting or multicasting transmission block to the plurality of receivers linked to the wireless network;
characterised in that each of the plurality of receivers is thereafter operable to receive such modulated layers, and demodulate and decode such layers, and reconstruct said data from said layers.

9. The system of claim 8 characterised in that base information is provided in the lowest layer and successively enriched or refined information in successively higher layers.

10. The system of claim 8 characterised in that a plurality of modulation means is provided or obtained, and in order to reduce data loss a particular modulation means is selected based on differences in wireless network conditions at different receivers.

11. The system of claim 8 characterised in that a modulation means associated with a relatively low SNR requirement is used for quality layers consisting of relatively low quality data, and a modulation means associated with a relatively high SNR requirement is used for quality layers consisting of relatively high quality data.

12. The system of claim 8 characterised in that a modulation means associated with a relatively low transmission rate is used for quality layers consisting of relatively low quality data, and a modulation means associated with a relatively high transmission rate is used for quality layers consisting of relatively high quality data.

13. The system of claim 8 characterised in that a relatively more robust protection encoding means is applied to quality layers consisting of relatively high quality data such that the recovery of these layers can be achieved by smaller amount of data successfully received in these layers, and a relatively less robust protection encoding means is applied to quality layers consisting of relatively low quality data such that the recovery of these layers can be achieved by relatively more amount of data successfully received in these layers.

14. A computer program product for transmitting data via a wireless network to a plurality of receivers characterised by a multicast or broadcast computer linked to the wireless network, the multicast or broadcast computer being characterised by:
(a) a computer readable medium including software instructions; and
(b) the software instructions for enabling the computer to perform predetermined operations, the predetermined operations including the steps of:
(i) separating the data into one or more quality layers;
(ii) converting the data in each quality layer into individual protected layer data streams by applying a protection or robustness means;
(iii) modulating each said protected layer data stream using a modulation means, the modulations means for each said protected layer data stream not necessarily being the same;
(iv) superimposing the modulated data of all layers into a single broadcasting or multicasting transmission block; and
(v) transmitting the single broadcasting or multicasting transmission block to the plurality of receivers linked to the wireless network;
characterised in that each of the plurality of receivers is thereafter operable to receive such modulated layers, and demodulate and decode such layers, and reconstruct said data from said layers.

15. The computer program product of claim 14 characterised in that base information is provided in the lowest layer and successively enriched or refined information in successively higher layers.

16. The computer program product of claim 14 characterised in that a plurality of modulation means is provided or obtained, and in order to reduce data loss a particular modulation means is selected based on differences in wireless network conditions at different receivers.

17. The computer program product of claim 14 characterised in that a modulation means associated with a relatively low SNR requirement is used for quality layers consisting of relatively low quality data, and a modulation means associated with a relatively high SNR requirement is used for quality layers consisting of relatively high quality data.

18. The computer program product of claim 14 characterised in that a modulation means associated with a relatively low transmission rate is used for quality layers consisting of relatively low quality data, and a modulation means associated with a relatively high transmission rate is used for quality layers consisting of relatively high quality data.

19. The computer program product of claim 14 a relatively more robust protection encoding means is applied to quality layers consisting of relatively high quality data such that the recovery of these layers can be achieved by smaller amount of data successfully received in these layers, and a relatively less robust protection encoding means is applied to quality layers consisting of relatively low quality data such that the recovery of these layers can be achieved by relatively more amount of data successfully received in these layers.

20. A system for receiving data transmitted through a wireless network by one or more multicast or broadcast systems, said data being encoded, modulated, and superimposed prior to transmission, the system characterised by a receiving computer linked to one or more subscriber stations operable to:
(a) receive a transmitted block of signals;
(b) demodulate the said transmitted block of signals into a superimposed set of data;
(c) separate the superimposed set of data into one or more encoded layers;
(d) decode said one or more encoded layers into one or more quality layers;
(e) recover the lost or corrupted data of one or more said quality layers; and
(f) reconstruct said data from said one or more quality layers.

21. A computer program product for receiving data transmitted through a wireless network by one or more multicast or broadcast systems, said data being encoded, modulated, and superimposed prior to transmission, characterised by a multicast or broadcast computer linked to one or more subscriber stations, the multicast or broadcast computer being characterised by:
(a) a computer readable medium including software instructions; and
(b) the software instructions for enabling the computer to perform predetermined operations, the predetermined operations including the steps of:
(i) receiving a transmitted block of signals;
(ii) demodulating the said transmitted block of signals into a superimposed set of data;
(iii) separating the superimposed set of data into one or more encoded layers;
(iv) decoding said one or more encoded layers into one or more quality layers;
(v) recovering the lost or corrupted data of one or more said quality layers; and
(vi) reconstructing said data from said one or more quality layers.
